(19) United States
(12) Patent Application Publication
(10) Pub. No.: US 2014/0003283 A1
(43) Pub. Date: Jan. 2, 2014

(54) NETWORK LANE RECONFIGURATION

(71) Applicants: David J. Koenen, Cypress, TX (US); Christopher C. Wanner, Houston, TX (US)

(72) Inventors: David J. Koenen, Cypress, TX (US); Christopher C. Wanner, Houston, TX (US)

(21) Appl. No.: 13/536,595

(22) Filed: Jun. 28, 2012

(51) Int. Cl. H04L 12/28

(52) U.S. Cl. 370/254

(57) ABSTRACT

Embodiments provide methods, apparatuses, and systems for transmitting an auto-negotiation message via one lane of a plurality of lanes to determine a link configuration between a first device and a second device, wherein the link configuration utilizes a plurality of lanes. In response to the auto-negotiation message, the network device may determine that one of the plurality of lanes is inoperative. The network device may then reconfigure the link configuration to utilize a subset of the plurality of lanes.

### BACKGROUND

Network switches and network interface cards (NICs), among other devices, utilize network media to transmit data. Network media may include different types of media, for example, cable, optical fibers, or traces on various printed circuit boards. The media may include multiple lanes which may be utilized in parallel to increase a throughput of data.

### BRIEF DESCRIPTION OF THE DRAWINGS

FIG. 1 is a block diagram of an apparatus in accordance with an example of the present disclosure;

FIG. 2 is a block diagram of a system in accordance with an example of the present disclosure;

FIG. 3 is a block diagram of a system in accordance with an example of the present disclosure; and

FIGS. 4-6 illustrate flow diagrams in accordance with various examples of the present disclosure.

### DETAILED DESCRIPTION

Computing devices, such as switches and network interface card (NIC) devices, among others, may utilize electrical conductors and/or optical fibers to transfer data. The electrical conductors and optical fibers may be disposed on a backplane or other printed circuit board, or alternatively, may be disposed within an insulator forming a cable. Multiple electrical conductors or optical fibers may be grouped together forming multiple lanes to increase the bandwidth of the media. To transmit data on the media, transmitters, connectors, and receivers may be utilized. If any one of these transmitters, connectors, receivers, or the media itself is not fully functional, the computing device will not link with an intended device. Without a link the devices cannot transfer data.

As the number of lanes increases, the potential for inoperable links similarly increases. For example, Ethernet connections are continually increasing their bandwidth and speed. Various examples include 10 Gb Ethernet and 100 Gb Ethernet. While this disclosure is discussed with reference to one or a few such link configurations, it is not intended to be so limited. Rather, this disclosure is expressly intended to cover other connections, bandwidths, speeds, protocols, and media.

In one example, two network devices may be coupled together via a multi-lane link. To establish a link, both network devices may advertise or transmit auto-negotiation data. Auto-negotiation data may be used to negotiate rates and other features over electrical conductors or optical links. In various examples the auto-negotiation data may be a Differential Manchester Encoding (DME) page, in accordance with various standards. Upon both network devices indicating a supported link configuration, data transmission on all lanes may occur. If one lane, transmitter, connector is inoperable, the network devices will fail to link. This is similarly true with optical links, although, DME pages may not be generally utilized within optical link infrastructures.

In the present disclosure, a manner and device suitable for providing a graceful degradation for a lane failure is provided. While not so limited, the present disclosure may enable degraded communication, with respect to an original link configuration, among Ethernet connections such as 40GBase-KR4, -SR4, -LR4, -CR4, 100GBase-LR4, -KR4, -CR4, among others. It may also be applied to Ethernet versions which utilize other numbers of lanes, for example 10 lane versions such as 100GBase-SR10, -CR10.

In addition to electrical conductors, various aspects of the disclosure may be applied to optical link configurations, for example 40GBase-SR4 and 100GBase-LR4. In various examples, the network devices may use detect signals to determine a number of active lanes and re-configure an intended link configuration to support another or degraded link configuration. As used herein, a link configuration is defined as a configuration between two network devices. A link configuration may describe a protocol, a speed, a number of utilized lanes, or other characteristics of the link.

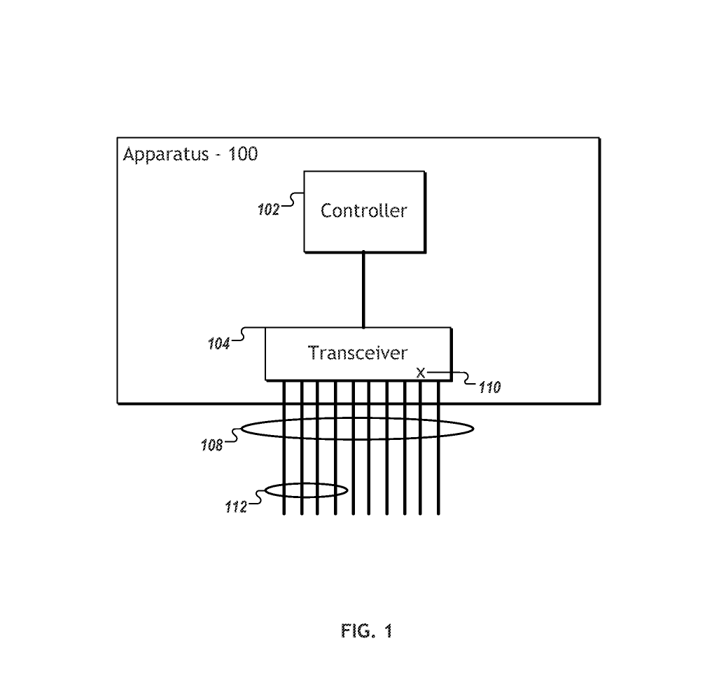

Referring to FIG. 1, an apparatus 100 is illustrated in accordance with an example of the present disclosure. The apparatus 100, in various examples, may be a network switch, a NIC, or another apparatus configured to transmit data over a network. The apparatus 100 includes a controller 102 and a transceiver 104. Other devices may be included without deviating from the scope of the disclosure.

Transceiver 104 is a device configured to send and receive data over a network. As illustrated the transceiver 104 is coupled to a multi-lane connection including a plurality of lanes 108. The transceiver is illustrated as a single device, however, the disclosure is not so limited. Rather, the functionality of the transceiver 104 may be embodied in multiple devices such as a transmitter and a receiver. The transceiver 104 is to transmit and receive signals on a plurality of lanes of network media 108 to a network device (not illustrated). The plurality of lanes 108, which may be referred to as network media, may include optical fibers, electrical conductors, and may be embodied within a PCB or housed within an insulator forming a cable.

The controller 102 may be an integrated circuit such as an Application Specific Integrated Circuit (ASIC) configured to execute instructions. The controller 102 may include other components such as processors and local memory to store the instructions. In other examples, the controller 102 may retrieve instructions for a separate memory, or alternatively, embody logic elements configured to perform a desired function. In one example, the controller 102 is configured to determine whether one of the plurality of lanes 108 supporting a first link configuration is inoperative, for example lane 110. In response to such a determination, the controller 102 may reconfigure the link configuration to utilize a subset of the plurality of lanes 112. In this manner, a link may be formed between the network devices, albeit degraded from the initial link configuration. Various examples will be discussed in more detail herein with reference to the remaining figures.

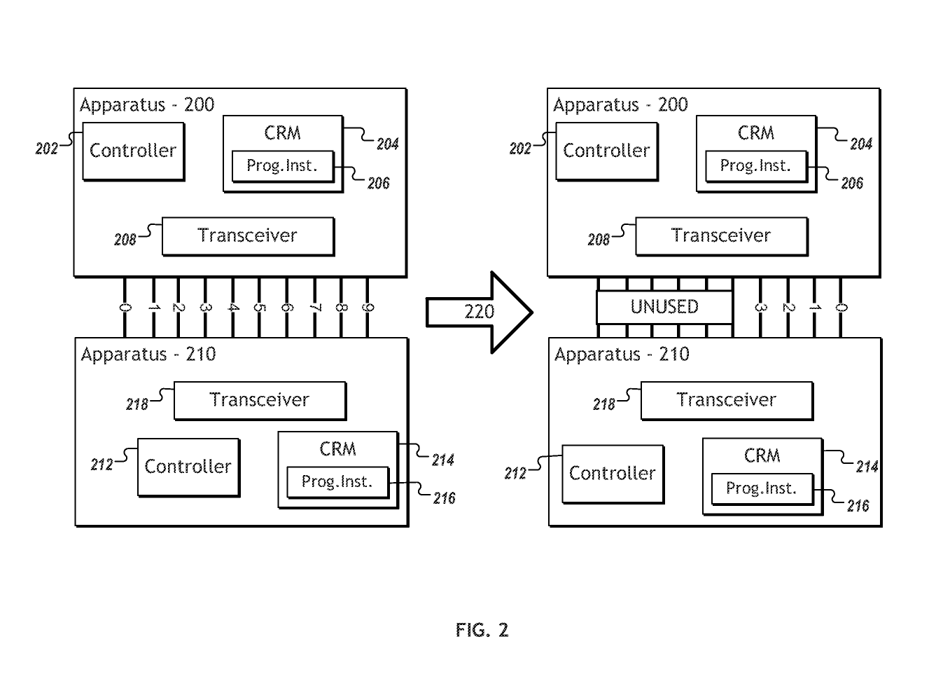

Referring to FIG. 2, a block diagram of a system is illustrated in accordance with another embodiment. Apparatus 200 includes a controller 202 similar to the controller 102 discussed with reference to FIG. 1; a computer readable medium 204 including programming instructions 206 which may be executed by the controller 202, and a transceiver 208 similar to the transceiver 104 discussed with reference to FIG. 1. The apparatus 200 is illustrated as being coupled to a second network device 210 via 10 lanes of media (0-9). The second network device 210 includes generally similar components to apparatus 200 for ease of discussion; however, while illustrated as being generally similar, the apparatus 200 and 210 are not so limited. Rather, each apparatus 200, 210 may include distinct components. Additionally, the number of lanes coupling apparatus 200 to apparatus 210 may also vary, dependent upon, for example, a link configuration.

In the illustrated example, apparatus 200 and apparatus 210 are configured to communicate via the plurality of lanes 0-9. To establish communication, apparatus 200, 210 transmit an auto-negotiation message across one lane, for example lane 0. Lane 0, among others, may be bi-direction or in other examples, may include a dedicated lane for each network device 200, 210. In the illustrated example, both network device 200, 210 transmit an auto-negotiation message. Assuming, lane 0 for network device 200 is inoperable, network device 210 may not receive the auto-negotiation message from network device 200. In contrast, network device 210 may be capable of successfully transmitting an auto-negotiation message, and network device 200 may receive the auto-negotiation message from network device 210.

Network device 200, up receiving the auto-negotiation message from network device 210 may determine a link configuration based upon the capabilities one or both devices 200, 210, In response, network device 200 may begin and/or continue transmitting signals on each lane 0-9. Upon transmission of signals on lanes 0-9, network device 210 may determine that a signal has not been received on lane 0. In response, the network link attempt may fail. Based upon this failure, network device 210 and network 200 may reverse their lane order and attempt to establish a network link utilizing a different link configuration. The different or reconfigured link configuration may be based upon the knowledge that lane 0 is inoperative.

Upon reversal of lanes, a reconfigured link configuration may be utilized. The reconfiguration is illustrated by arrow 220. As illustrated, the network devices 200, 210 have reversed their lane order. In other words, previous lane 9 is new lane 0, previous lane 8 is new lane 1, previous lane 7 is new lane 2, and so forth. In reversing the lanes, a new link configuration has been established.

In response to a lane reversal, another auto-negotiation process may ensue. For example, the network devices 200, 210 may transmit another auto-negotiation message via new lane 0 (previous lane 9). In response to the new auto-negotiation message being received at each network device 200, 210, the devices may attempt to link. Upon transmitting of signals across all lanes (0-9), one or both devices 200, 210, may again determine that lane 9 (previous lane 0) remains inoperable, and that the devices may reconfigure the current link configuration to enable a degraded link (again, degraded with response to the original link configuration). The determination of how the network devices 200, 210 may reconfigure the link configuration may be based on many factors including the transmission capabilities of the network devices 200, 210, the maximum bandwidth available, or a predetermined bandwidth based upon predefined preferences.

In the illustrated example, the degraded link configuration utilizes 4 lanes. This may represent a degradation of 100GBase-CR10 to 40GBase-CR4. As stated previously, the network devices may incorporate various numbers of lanes, and may degrade the lane configurations to various numbers of lanes. In the illustrated embodiment, the new lanes 4-9 are unused. While this represents a loss in bandwidth, it may enable a network connection. In addition, once connected, the status of the link configuration may be transmitted to multiple network devices 200, 210 indicating the link configuration and the inoperative lane.

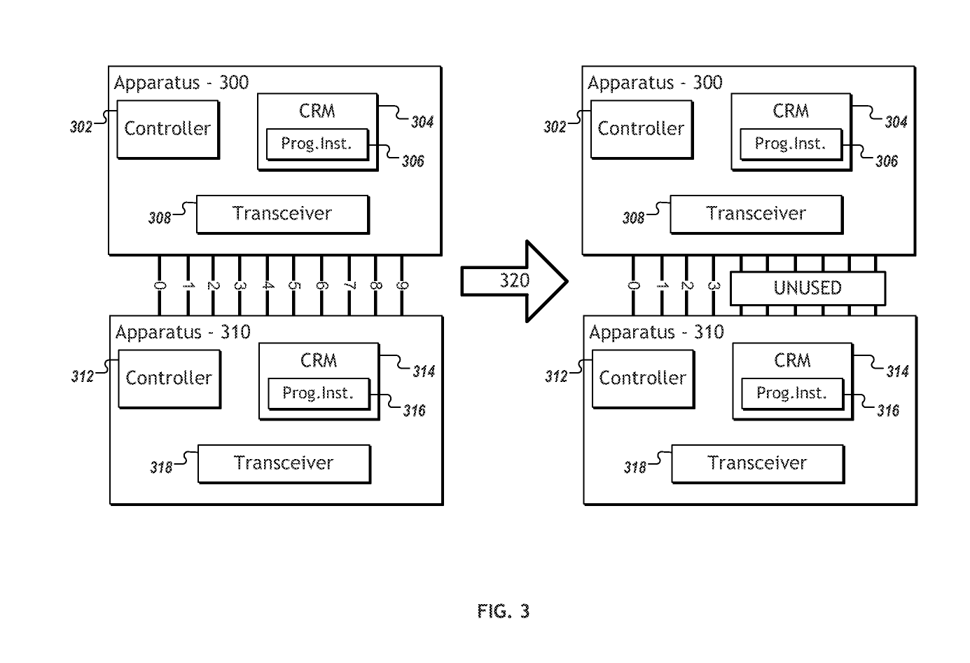

Referring to FIG. 3, another example block diagram is illustrated. Similar to FIG. 2, two network devices 300, 310 are illustrated with similar components. As illustrated, apparatus 300 is coupled to apparatus 310 via ten lanes (0-9). The lanes may be optical fibers or electrical conductors.

To establish communication utilizing an electrical conductor link configuration, apparatus 300, 310 transmit an auto-negotiation message across one lane, for example lane 0. Lane 0, among others, may be bi-direction or in other examples may include a dedicated lane for each network device 300, 310. Alternatively, in an optical link configuration, devices 300, 310 may not support transmission of auto-negotiation messages, but utilize a parallel detect mechanism to detect and link for different number of lanes or speeds on a single lane.

Upon the transmission of the auto-negotiation message, or alternatively, the parallel detect mechanism in an optical link configuration, one or both devices 300, 310 may attempt to establish a link utilizing a link configuration negotiated via the auto-negotiation message or parallel detect mechanism. This may, in various examples, entail transmitting signals on predetermined lanes of the plurality of lanes. In response to the transmission, the network devices 300, 310 may determine that one or more lanes of the plurality of lanes 0-9 is/are inoperable. The determination of inoperability may be based on the absence of a signal on one lane and the presence of a signal on others.

In response to the determination, one or both devices 300, 310 may attempt to reconfigure the link configuration. Reconfiguration of the link configuration may include utilizing a subset of the plurality of lanes 0-9. In the illustrated embodiment, lane 5 may have experienced a lane fault. In response, network devices 300, 310 may reconfigure the link, as indicated by arrow 320, to utilize a subset of the plurality of lanes. As illustrated, the network devices 300, 310 utilize 4 lanes. This is illustrated as lanes 0-4 while the remaining lanes are illustrated as being unused. While this represents a loss in bandwidth, it may enable a network connection that would otherwise not be available. In various examples, once connected, the status of the link configuration may be transmitted to multiple network devices 300, 310 indicating the link configuration and the one or more inoperative lanes. This may again, represent a degradation from 100GBase-CR10 to 40GBase-CR4. Other degradations are also contemplated.

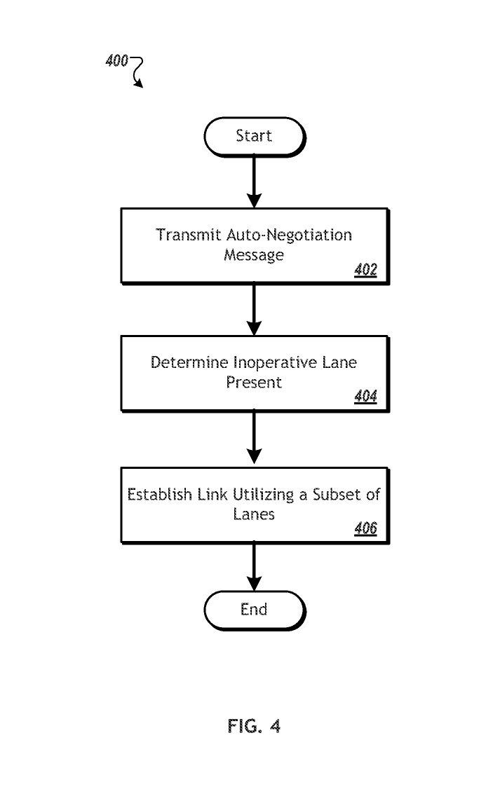

Referring to FIGS. 4-6 flow diagrams are illustrated in accordance with various examples of the present disclosure. The flow diagrams illustrated elements that may represent processes performed by any of the network devices discussed herein, or alternatively, may represent programming instructions, which when executed by a device, cause the device perform various functions. Additionally, while illustrated in a particular order, the discussion and associated figures are not intended to be so limited. Rather, various elements may be performed simultaneously or in other orders in different examples.

Referring to FIG. 4, a flow diagram is illustrated in accordance with one example of the present disclosure. The flow diagram begins and proceeds to 402 where a device may transmit an auto-negotiation message via one lane of a plurality of lanes to determine a link configuration between a first device and a second device. In various examples, the link configuration may utilize a plurality of lanes. The auto-negotiation message may be transmitted from each network device to the other utilizing a first lane.

In response to the auto-negotiation message, one or both network devices may determine that one of the plurality of lanes is inoperative at 404. The determination may be in response to receipt of a signal on one or more lanes and the absence of a signal on the inoperative lane, the absence indicating an inoperative lane,

In response to a determination of an inoperable lane, the network devices may reconfigure the link configuration at 406. The reconfigured link configuration may utilize a subset of the plurality of lanes. The subset may represent all lanes, but for the inoperable lane, or alternatively, may utilize a predetermined number of lanes based upon the determined link configuration. The flow diagram may then end.

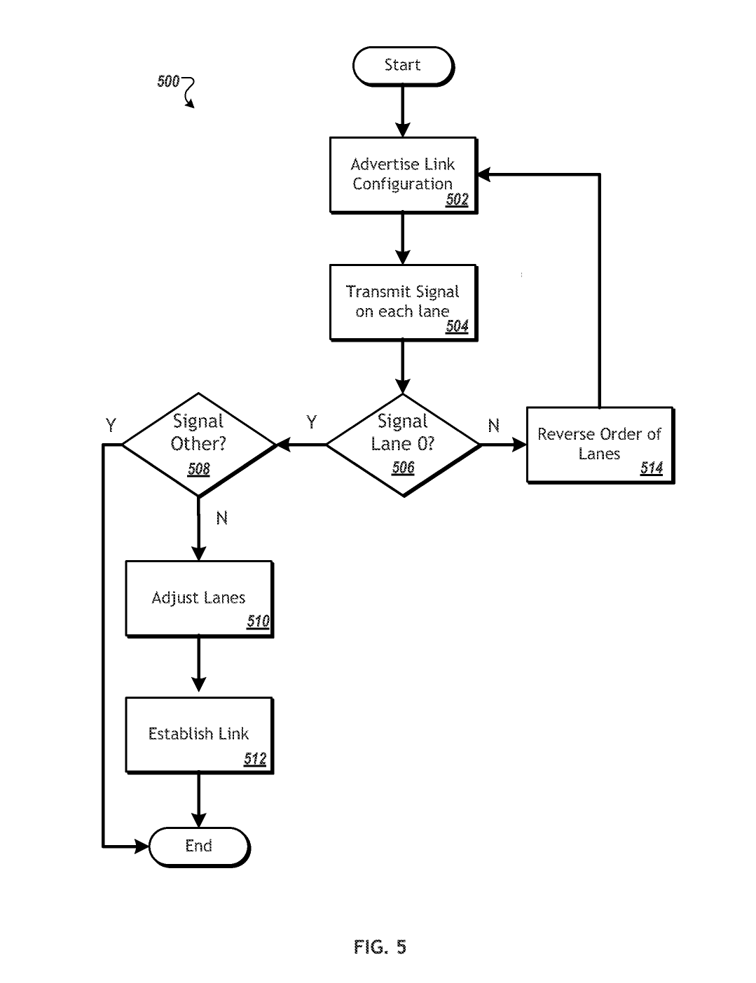

Referring to FIG. 5, another flow diagram is illustrated in accordance with another example. The flow diagram 500 may begin and progress to 502, where one or more network devices may advertise a link configuration. In various examples, the link configuration advertised may include a connection speed, a number of possible lanes, and, other characteristics of the link. The advertisement may be in the form of an auto-negotiation message.

In response to the advertisement, one or more network devices may transmit signals on each lane at 504. In various examples, the signals may be a Direct Current (DC) bias signal, although other signals are contemplated. Once received at a network device, the network device may determine whether a signal was received on lane 0 at 506. In response to detecting a signal on lane 0, the network device may determine whether signals on other lanes are present at 508.

If, at 508, signals are present on all lanes associated with the link configuration, the flow diagram may end. Alternatively, if a signal is not detected on one or more of the other lanes at 508, the network device may adjust a number of lanes at 510. Adjusting a number of lanes at 510 may include determining a maximum bandwidth available in light of the inoperable inks. The determination may be dynamic or predetermined. For example, a network device may determine a number of operable lanes, or alternatively, the network device may default to a minimum, for example, a single lane.

At 512, based upon the adjusted lanes within a reconfigured link configuration, the network devices may establish a link. The link may be degraded with respect to the original link configuration. Subsequently, the flow diagram may end.

Returning to 506, if a signal is not detected on lane 0, then flow diagram may proceed to 514, where the network devices may reverse the order of their lanes. Once the lanes have been reversed at 514, the method may continue back to 502 where the network devices again advertise for one or more link configurations. The reversal of the lanes enables the devices to again attempt to connect at a first link configuration, and subsequent to a determination that a lane is inoperable (i.e., the original lane 0) reconfigure the link configuration utilizing a subset of the plurality of lanes. With the lanes adjusted, at 510, the network devices may establish a link at 512. The flow diagram may then end.

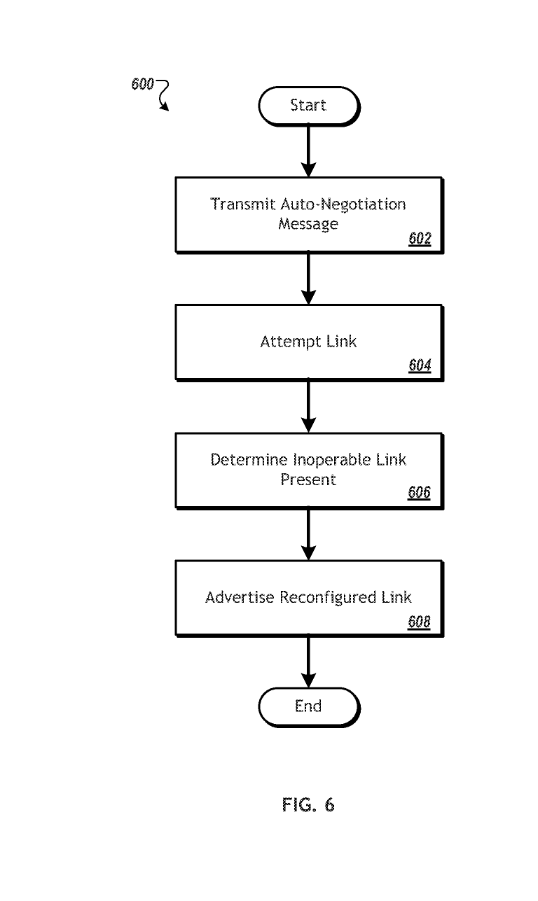

Referring to FIG. 6, another flow diagram is illustrated in accordance with an example of the present disclosure. The flow diagram 600 may begin and proceed to 602 where a network device may advertise a link configuration to a link partner. The advertisement, in one example, may be an auto-negotiation message; however, other advertisements are contemplated.

In response to the advertisement, the network device may attempt to establish a link with another network device (i.e., link partner) utilizing the link configuration at 604. In one example, the link configuration may utilize a plurality of lanes of network media coupling the two network devices together. In various examples, the plurality of lanes may include 2, 4, 10, or other numbers of lanes.

While attempting to establish the link, a network device may determine that one of the plurality of lanes of the network media is inoperable at 606. The determination may be based on the absence of a signal being received via one or more of the plurality of lanes. In response to the determination, the network device may reconfigure the link configuration to utilize a subset of the plurality of lanes, the subset excluding the inoperable lane. The flow diagram may then end. In various examples, ending may include the establishment of a link at another link configuration.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

What is claimed is:

1. A method, comprising:
transmitting an auto-negotiation message via one lane of a plurality of lanes to determine a link configuration between a first device and a second device, wherein the link configuration utilizes a plurality of lanes;
determining that one of the plurality of lanes is inoperative in response to the auto-negotiation message; and
reconfiguring the link configuration between the first device and the second device in response to the determining, wherein the reconfigured link configuration utilizes a subset of the plurality of lanes.

2. The method of claim 1, wherein determining that one of the plurality of lanes is inoperative comprises transmitting a signal on each of the plurality of lanes and determining that one signal was not received.

3. The method of claim 1, wherein determining that one of the plurality of lanes is inoperative comprises determining that a first lane of the plurality of lanes is inoperative.

4. The method of claim 3, further comprising:
reversing an order of the plurality of lanes; and
transmitting a second auto-negotiation message.

5. The method of claim 1, further comprising:
transmitting a second auto-negotiation message in response to the determining, wherein the second auto-negotiation message includes an advertisement for the reconfigured link configuration.

6. The method of claim 1, wherein transmitting the auto-negotiation message via one of the plurality of lanes comprises transmitting the auto-negotiation message via a first lane.

7. The method of claim 1, wherein reconfiguring the link configuration between the first device and the second device comprises determining a link configuration that utilizes a maximum number of operable lanes.

8. An apparatus, comprising:
a transceiver to transmit and receive signals on a plurality of lanes of network media to a network device; and
a controller coupled to the transceiver, wherein the controller is to determine whether one of the plurality of lanes supporting a first link configuration is inoperative and reconfigure the link configuration to utilize a subset of the plurality of lanes.

9. The apparatus of claim 8, wherein the network media comprises optical fibers.

10. The apparatus of claim 8, wherein the network media comprises electrical cables.

11. The apparatus of claim 8, wherein the first transmission speed is a 100GBase-CR10 connection and the second transmission speed is a 40GBase-CR4 Connection.

12. The apparatus of claim 8, wherein the controller is to determine whether one of the plurality of lanes is inoperative in response to exchange of an auto-negotiation message.

13. The apparatus of claim 12, wherein the controller is further to reverse an order of the plurality of lanes in response to the failure.

14. The apparatus of claim 8, wherein the controller is to determine whether one of the plurality of lanes is inoperative via a failure to receive a signal on one of the plurality of lanes.

15. The apparatus of claim 8, wherein the subset of the plurality of lanes includes all but one of the plurality of lanes.

16. The apparatus of claim 8, wherein the controller is to advertise a second link configuration in response to a determination of an inoperative lane.

17. The apparatus of claim 8, wherein the controller is configured to advertise a link configuration on both a first lane and a second lane.

18. A non-transitory computer readable medium including a plurality of programming instructions stored thereon, wherein the plurality of programming instructions, if executed, cause a network device to:
advertise a link configuration to a link partner;
attempt to establish a link with the link partner utilizing the link configuration, wherein the link configuration utilizes a plurality of lanes of network media coupling the network device to the link partner;
determine that one of the plurality of lanes of network media is inoperable; and
reconfigure the link configuration to utilize a subset of the plurality of lanes, the subset excluding the inoperable lane.

19. The non-transitory computer readable medium of claim 18, wherein the programming instructions, if executed, further cause the network device to:
reverse an order of the plurality of lanes.

20. The non-transitory computer readable medium of claim 18, wherein the programming instructions, if executed, further cause the network device to:
establish a link with the link partner at the degraded speed.
